(19) United States
(12) Patent Application Publication
(10) Pub. No.: US 2017/0036418 A1
(43) Pub. Date: Feb. 9, 2017

(54) PANEL SYSTEM COMPRISING MAGNETICALLY RESPONSIVE ELEMENTS

(71) Applicant: Milliken & Company, Spartanburg, SC (US)

(72) Inventors: Sudhanshu Srivastava, Greer, SC (US); Venkatkrishna Raghavendran, Houston, TX (US); Dale S. Kitchen, Boiling Springs, SC (US); Keith A. Keller, Spartanburg, SC (US); LeAnne O. Flack, Greer, SC (US); Daniel T. McBride, Chesnee, SC (US)

(21) Appl. No.: 15/224,615

(22) Filed: Jul. 31, 2016

Related U.S. Application Data
(60) Provisional application No. 62/201,316, filed on Aug. 5, 2015.

(51) Int. Cl. B32B 5/26; B32B 5/02

(52) U.S. Cl. CPC B32B 5/26; B32B 5/028; B32B 5/022; B32B 2255/02; B32B 2264/105; B32B 2264/102; B32B 2307/208; B32B 2607/00

(57) ABSTRACT

A panel system comprises: (a) a rigid panel having a first surface, the first surface having a coating thereon, the coating comprising a binder and a particulate material selected from the group consisting of paramagnetic particles, superparamagnetic particles, ferromagnetic particles, ferrimagnetic particles, and mixtures thereof; and (b) a cover layer adjacent to and in contact with the first surface of the rigid panel. In an alternative embodiment, the coating can be disposed on the cover layer. In another alternative embodiment, the coating can be disposed on an intermediate fabric layer that is positioned between the rigid panel and the cover layer.

### CROSS-REFERENCE TO RELATED PATENT APPLICATIONS

This application claims, pursuant to 35 U.S.C. §119(e), priority to and the benefit of the filing date of U.S. Patent Application No. 62/201,316 filed on Aug. 5, 2015, which application is hereby incorporated by reference in its entirety.

### TECHNICAL FIELD OF THE INVENTION

This application relates to panel systems having one or more magnetically responsive elements. The panel systems are suitable for use in the partitions of office furniture systems.

### BRIEF SUMMARY OF THE INVENTION

In a first embodiment, the invention provides a panel system comprising:

(a) a rigid panel having a first surface, the first surface having a coating on at least a portion thereof, the coating comprising a binder and a particulate material selected from the group consisting of paramagnetic particles, superparamagnetic particles, ferromagnetic particles, ferrimagnetic particles, and mixtures thereof; and

(b) a cover layer adjacent to and in contact with the first surface of the rigid panel.

In a second embodiment, the invention provides a panel system comprising:

(a) a rigid panel,

(b) a cover layer having a first surface, the first surface of the cover layer being adjacent to and in contact with the rigid panel, the first surface of the cover layer having a coating on at least a portion thereof, the coating comprising a binder and a particulate material selected from the group consisting of paramagnetic particles, superparamagnetic particles, ferromagnetic particles, ferrimagnetic particles, and mixtures thereof.

In a third embodiment, the invention provides a panel system comprising:

(a) a rigid panel having a first surface;

(b) a first fabric layer adjacent to and in contact with the first surface of the rigid panel, the first fabric layer comprising a coating on at least a portion of one surface of the first fabric layer, the coating comprising a binder and a particulate material selected from the group consisting of paramagnetic particles, superparamagnetic particles, ferromagnetic particles, ferrimagnetic particles, and mixtures thereof; and

(c) a cover layer adjacent to and in contact with the first fabric layer.

### BRIEF DESCRIPTION OF THE DRAWINGS

FIG. 1 is an exploded, perspective view of a panel system according to the invention.

FIG. 2 is an exploded, perspective view of another panel system according to the invention.

FIG. 3 is an exploded, perspective view of another panel system according to the invention.

### DETAILED DESCRIPTION OF THE INVENTION

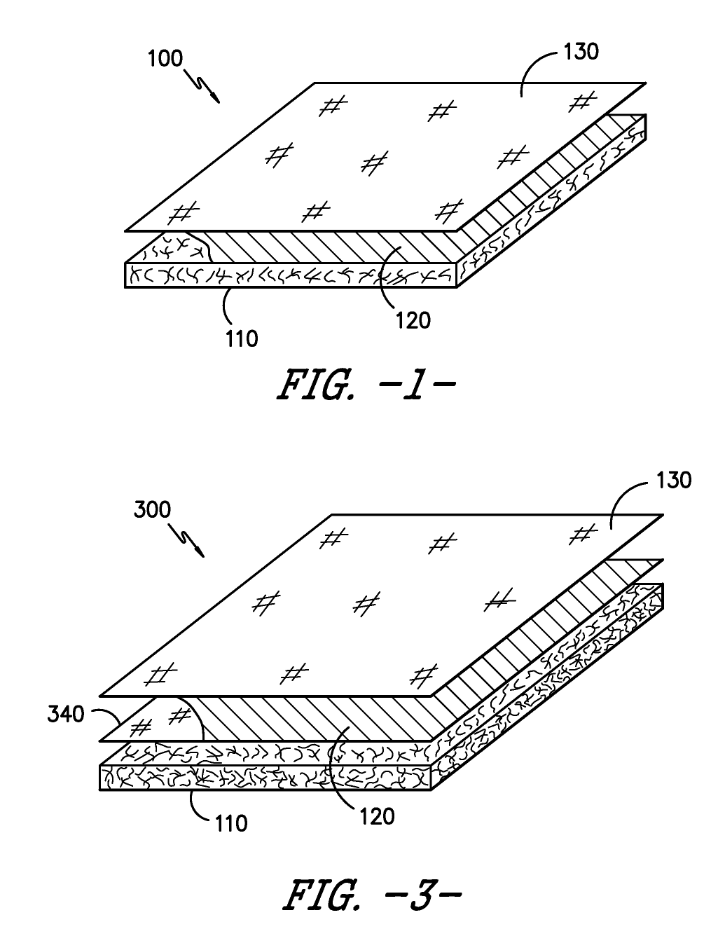

In a first embodiment, such as that depicted in FIG. 1, the invention provides a panel system 100 comprising a rigid panel 110 and a cover layer 130. The rigid panel 110 has a first surface, and a coating 120 is disposed on at least a portion of the first surface of the rigid panel 110. In practice, the cover layer 130 is disposed adjacent to the first surface of the rigid panel 110 and in contact with the coating 120 applied to the rigid panel 110.

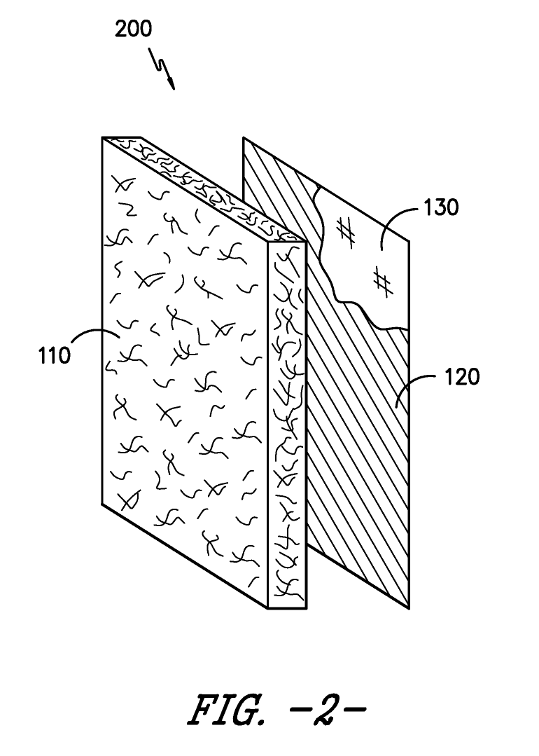

In a second embodiment, such as that depicted in FIG. 2, the invention provides a panel system 200 comprising a rigid panel 110 and a cover layer 130. The cover layer 130 has a first surface, and a coating 120 is disposed on at least a portion of the first surface of the cover layer 130. The first surface of the cover layer 130 and the coating 120 thereon are disposed adjacent to and in contact with the rigid panel 110.

In a third embodiment, the invention provides a panel system in which the coating is disposed on an intermediate fabric layer that lies between the rigid panel and the cover layer. In particular, as depicted in FIG. 3, the panel system 300 comprises a rigid panel 110, a first fabric layer 340, and a cover layer 130. The rigid panel 110 has a first surface and the first fabric layer 340 is adjacent to and in contact with the first surface of the rigid panel 110. The first fabric layer 340 comprises a coating 120 on at least a portion of at least one surface of the first fabric layer 340. In FIG. 3, the panel system is depicted with the coating 120 disposed on the distal surface of the first fabric layer 340 relative to the rigid panel 110. However, the coating can alternatively be disposed on the proximal surface of the first fabric layer relative to the rigid panel. In yet another embodiment, such as when the first fabric layer is a relatively open construction, the coating can be disposed on both major surfaces of the first fabric layer (i.e., the surfaces proximal and distal to the first surface of the rigid panel). The cover layer 130 is disposed adjacent to and in contact with the first fabric layer 340.

The rigid panel 110 can be any suitable rigid material that provides structural support for the panel system. Suitable materials for the rigid panel include, but are not limited to, metal, wood, engineered wood, natural fiber plastic composites, glass, and rigid textile materials (e.g., rigid nonwoven textile materials). Preferably, the rigid panel is constructed from a material that absorbs sound. In a preferred embodiment, the rigid panel is a nonwoven textile material. Suitable nonwoven textile materials can be constructed from any suitable fiber or combination of fibers. For example, the nonwoven textile material can be constructed from natural fibers (e.g., bast fibers or cellulose fibers), synthetic fibers (e.g., polyester fibers or polyolefin fibers), and mixtures thereof. Nonwoven textile materials suitable for use as the rigid panel in the system of the invention include, but are not limited to, the non-woven composites described in U.S Pat. No. 7,871,947 (Flack) issued on Jan. 18, 2011 and U.S. Pat. No. 7,998,890 (Flack) issued on Aug. 16, 2011, both of which are incorporated herein by reference.

The cover layer 130 can be any suitable material that cover and preferably conceals the rigid panel 110 (as depicted in FIGS. 1 and 2) or the rigid panel 110 and the first fabric layer 340 (as depicted in FIG. 3). Generally, the cover layer 130 is a decorative surface that is visible to observers and passersby when the panel system is installed in, for example, office furniture located in an office environment. Thus, the cover layer 130 generally incorporates at least one decorative element, such as color, texture, pattern, or any desirable combination of the three. The cover layer 130 can be a textile material or a composite material. Suitable composite materials include, but are not limited to, laminates of paper, wood, and/or fabric impregnated with a thermosetting resin, such as a melamine resin. The cover layer 130 preferably is selected from the group consisting of knit textile materials, woven textile materials, and nonwoven textile materials, with woven textile materials being generally more preferred.

The first fabric layer 340 can be any suitable fabric. Because the first fabric layer 340 is covered by the cover layer 130, the first fabric layer 340 can be a lighter weight and open construction fabric. In a preferred embodiment, the first fabric layer 340 is a scrim. As utilized herein, the term “scrim” refers to (1) lightweight, coarse, open-weave fabrics and (2) fabrics made by adhering together two or more yarns sheets laid in such a way that two sheets are approximately perpendicular to one another. Suitable examples of scrims include, but are not limited to, woven, knit, flat bond, point bond, and spunlace fabrics made from natural fibers, synthetic fibers, and mixtures thereof. Suitable synthetic fibers include, but are not limited to, thermoplastic synthetic fibers, such as polyesters (e.g., polyethylene terephthalate), polyolefins (e.g., polyethylene and polypropylene), and polyamides (e.g., nylon). The scrim preferably has a weight of about 15 g/m² or more, such as in the case of flat bond, point bond, and spunlace scrims. For woven and knit scrims, the scrim preferably has a weight of about 30 g/m² or more, more preferably about 65 g/m² or more.

The panel system 100, 200, 300 comprises a coating 120. The coating can be present on the target substrate (i.e., rigid panel 100 in FIG. 1, cover layer 130 in FIG. 2, or first fabric layer 340 in FIG. 3) in any suitable amount. Generally, the amount of coating applied to the substrate will depend upon the desired strength of the magnetic response. This will also depend, at least in part, on the amount of particulate material present in the coating and the magnetic susceptibility of that particulate material. The coating preferably is present on the target substrate in an amount of about 100 g/m² or more, about 150 g/m² or more, about 170 g/m² or more, about 200 g/m² or more, about 250 g/m² or more, about 300 g/m² or more, or about 340 g/m² or more.

The coating 120 comprises a particulate material and a binder. The particulate material in the coating is magnetically responsive and exhibits a positive magnetic susceptibility (X). Preferably, the particulate material is selected from the group consisting of paramagnetic particles, superparamagnetic particles, ferromagnetic particles, ferrimagnetic particles, and mixtures thereof. More preferably, the particulate material is selected from the group consisting of paramagnetic particles, superparamagnetic particles, and mixtures thereof. Preferably, the particulate material is selected from the group consisting of iron particles, iron oxide particles, and mixtures thereof. In a preferred embodiment, the particulate material comprises iron oxide particles, such as Fe₂O₃ particles and Fe₃O₄ particles. Iron oxide particles are generally preferred over iron particles because iron particles may rust in high humidity environments, and such rusting can discolor one or more components of the panel system.

The particulate material can have any suitable particle size. Preferably, the particulate material has a particle size of about 100 microns or less. More preferably, the particulate material has a particle size of about 50 microns or less. The particle size of the material can affect the magnetic response exhibited by the particulate material. Generally, the magnetic susceptibility of the particles increases with decreasing particle size. Thus, iron oxide particles having a particle size of 50 nm or larger are generally paramagnetic, owing to the fact that individual particles are sufficiently large to possess two or more magnetic domains. Iron oxide particles having a particle size less than 50 nm are generally superparamagnetic, owing to the fact that individual particles are sufficiently small that they possess only one magnetic domain.

The particulate material can be present in the coating in any suitable amount. The amount of particulate material present in the coating may depend upon several factors, such as the desired strength of the magnetic response and the type of particulate material(s) used in the coating. Generally, in order to achieve a sufficiently strong magnetic response, the particulate material(s) generally account for an appreciable percentage of the overall coating. Preferably, the particulate material is present in the coating in an amount of about 20 wt. % or more of the coating. In a more preferred embodiment, the particulate material is present in the coating in an amount of about 20 wt. % to about 90 wt. % (e.g., about 30 wt. % to about 90 wt. %, about 40 wt. % to about 90 wt. %, about 50 wt. % to about 90 wt. %, or about 60 wt. % to about 90 wt. %), about 30 wt. % to about 80 wt. %, about 40 wt. % to about 80 wt. %, about 50 wt. % to about 80 wt. %, or about 60 wt. % to about 80 wt. % of the coating.

The binder in the coating 120 can be any binder suitable for use on textile materials or in textile applications. Preferably, the binder remains flexible after curing, which will allow the fabric substrates to be wrapped around the rigid panel and also permit the coating to be perforated, such as when an individual attaches an article to the panel using a tack or push pin. Preferably, the binder is selected from the group consisting of urethane binders, acrylic binders, silicone binders, and mixtures thereof.

The layers of the system can be held together by any suitable means. For example, individual layers (e.g., the rigid panel 110 and the cover layer 130, the rigid panel 110 and the first fabric layer 340, or the first fabric layer 340 and the cover layer 130) can be adhered or laminated to one another using any suitable adhesive or binder. Alternatively, the cover layer 130 and, if present, the first fabric layer 340 can be attached to the rigid panel 110 using mechanical fasteners, such as staples, tacks, or clips. When using mechanical fasteners, the cover layer and/or the first fabric layer can be wrapped around the edges of the rigid panel and attached to the reverse side of the panel using the mechanical fasteners.

As noted above, the particulate material present in the coating is magnetically responsive and exhibits a positive magnetic susceptibility (X). Thus, an externally applied magnetic field will induce magnetic fields in the particulate material, and these induced magnetic fields are in the same direction as the externally applied magnetic field. The externally applied magnetic field therefore attracts the particulate material, which attraction produces a force drawing together the particulate material and the source of the externally applied magnetic field. When the magnetic response of the particulate material is sufficiently strong and enough of the particulate material is present, one can use this attractive force to attach magnetic materials (i.e., materials possessing a permanent magnetic field) to the substrate carrying the coating and/or a panel system incorporating the coating.

As will be apparent from the description of the magnetically responsive particulate materials set forth above, the coatings containing these materials will typically be dark in color, especially when relatively high loadings of particles are present in the coating. While a dark-colored coating may not be problematic for certain applications, such as on dark colored surfaces or surfaces that are not visible to users, there may be some instances in which a dark coating is not be desirable. For example, a dark coating on a light-colored fabric may detract from the overall visual aesthetic of the fabric or a panel system containing the fabric. Thus, in certain embodiments, an additional coating is disposed on top of the coating containing the magnetically responsive particulate material. Such coating can comprise any of the binders disclosed above for the coating containing the magnetically responsive particulate material. In addition to the binder, the coating further comprises a particulate material that masks the color of the underlying coating containing the magnetically responsive particulate material. One suitable class of such particles is pigments, such as titanium dioxide. When pigments are used, the pigment(s) can be selected to produce a coating having a color that matches or at least complements the color of the substrate to which it is applied.

As is briefly noted above, the panel system is believed to be suitable for a variety of uses in an office environment. For example, the panel system can be attached to the inside wall of a building or room to provide a decorative surface to which one can attach materials using magnets (e.g., attach papers using magnetic buttons). Furthermore, when the rigid panel is made from a material that absorbs sound, such a deployment of the panel system would have the added benefit of reducing ambient noise inside the building or at least the room containing the panel. The panel system can also be used in the partitions of modular office furniture systems, such as cubicles. In such an application, the panel system would permit one to attach papers and other materials to the partition using magnets, thereby avoiding damage to the decorative fabric surface caused by using tacks, pushpins, or tape. Currently, manufacturers use metal panels to produce such partitions, but metal panels tend to reflect sound rather than absorb it. Thus, the panel system of the invention, which can incorporate a rigid panel that absorbs sound, can provide the added benefit of reducing ambient noise in the work environment.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A panel system comprising:
(a) a rigid panel having a first surface, the first surface having a coating thereon, the coating comprising a binder and a particulate material selected from the group consisting of paramagnetic particles, superparamagnetic particles, ferromagnetic particles, ferrimagnetic particles, and mixtures thereof; and
(b) a cover layer adjacent to and in contact with the first surface of the rigid panel.

2. The panel system of claim 1, wherein the rigid panel is a nonwoven textile material.

3. The panel system of claim 1 or claim 2, wherein the binder is selected from the group consisting of acrylic binders, urethane binders, silicone binders, and mixtures thereof.

4. The panel system of any of claims 1-3, wherein the particulate material is selected from the group consisting of iron particles, iron oxide particles, and mixtures thereof.

5. The panel system of any of claims 1-4, wherein the particulate material has a particle size less of about 100 μm or less.

6. A panel system comprising:
(a) a rigid panel,
(b) a cover layer having a first surface, the first surface of the cover layer being adjacent to and in contact with the rigid panel, the first surface of the cover layer having a coating on at least a portion thereof, the coating comprising a binder and a particulate material selected from the group consisting of paramagnetic particles, superparamagnetic particles, ferromagnetic particles, ferrimagnetic particles, and mixtures thereof.

7. The panel system of claim 6, wherein the rigid panel is a nonwoven textile material.

8. The panel system of claim 6 or claim 7, wherein the binder is selected from the group consisting of acrylic binders, urethane binders, silicone binders, and mixtures thereof.

9. The panel system of any of claims 6-8, wherein the particulate material is selected from the group consisting of iron particles, iron oxide particles, and mixtures thereof.

10. The panel system of any of claims 6-9, wherein the particulate material has a particle size less of about 100 μm or less.

11. A panel system comprising:
(a) a rigid panel having a first surface;
(b) a first fabric layer adjacent to and in contact with the first surface of the rigid panel, the first fabric layer comprising a coating on at least one surface of the first fabric layer, the coating comprising a binder and a particulate material selected from the group consisting of paramagnetic particles, superparamagnetic particles, ferromagnetic particles, ferrimagnetic particles, and mixtures thereof; and
(c) a cover layer adjacent to and in contact with the first fabric layer.

12. The panel system of claim 11, wherein the rigid panel is a nonwoven textile material.

13. The panel system of claim 11 or claim 12, wherein the first fabric layer is a scrim.

14. The panel system of any of claims 11-13, wherein the binder is selected from the group consisting of acrylic binders, urethane binders, silicone binders, and mixtures thereof.

15. The panel system of any of claims 11-14, wherein the particulate material is selected from the group consisting of iron particles, iron oxide particles, and mixtures thereof.

16. The panel system of any of claims 11-15, wherein the particulate material has a particle size less of about 100 μm or less.
